(19) United States
(12) Patent Application Publication
(10) Pub. No.: US 2015/0003272 A1
(43) Pub. Date: Jan. 1, 2015

(54) UPLINK OVERLOAD INDICATOR FOR TIME DIVISION DUPLEX WIRELESS COMMUNICATION SYSTEMS

(71) Applicants: Teck Hu, Melbourne, FL (US); Jiyong Pang, Shanghai (CN)

(72) Inventors: Teck Hu, Melbourne, FL (US); Jiyong Pang, Shanghai (CN)

(73) Assignee: ALCATEL LUCENT, Boulogne Billancourt (FR)

(21) Appl. No.: 14/375,235

(22) PCT Filed: Jan. 29, 2012
(86) PCT No.: PCT/CN2012/070734

§ 371 Date: Jul. 29, 2014

(51) Int. Cl. H04W 72/08; H04W 24/02; H04L 5/14

(52) U.S. Cl. CPC H04W 72/082; H04L 5/14; H04W 24/02
USPC 370/252; 370/280

(57) ABSTRACT

Embodiments of the claimed subject matter provide a method and apparatus for transmitting an uplink overload indicator in a wireless communication system that operates according to time division duplexing. One embodiment of the method includes transmitting, from a first base station to a second base station, a message indicating that the first base station detected interference in at least one subframe of a time division duplex (TDD) frame allocated for reception of uplink signals at the first base station. A portion of the interference is generated by downlink transmissions from the second base station in the subframe of the TDD frame.

### CROSS REFERENCE TO RELATED APPLICATIONS

This application is related to U.S. patent application Ser. No. ______, filed on ______. [ADD INFORMATION FOR RELATED APP 811301, 2100.049300]

### BACKGROUND

This application relates generally to communication systems, and, more particularly, to wireless communication systems.

Wireless communication systems include a network of devices for providing wireless connectivity to wireless-enabled devices including mobile units, smart phones, tablet devices, laptops, desktops, and other types of user equipment. The network access devices include base stations, base station routers, access points, e-node-Bs (eNBs), and the like. The entities within the wireless communication system generally conform to standards and/or protocols that facilitate communication over the air interface. For example, wireless communication systems are currently being developed that operate according to the Long Term Evolution (LTE) standards and/or protocols defined by the Third Generation Partnership Project (3GPP, 3GPP2). The LTE-Advanced standard supports both frequency division duplexing (FDD) and time division duplexing (TDD). Service providers are expected to implement both types of systems depending on the circumstances of the deployment scenario. The advantages to deploying a TDD system include efficient use of the radio spectrum because TDD uses a single frequency resource and does not require the paired set of frequency resources used to implement FDD.

Interference between neighboring base stations and/or user equipment can reduce the benefits of resource sharing in a TDD system. For example, base-station-to-base-station (BS-to-BS) interference occurs when one base station transmits a downlink signal to user equipment in a subframe while another base station is attempting to receive an uplink signal from other user equipment during the same subframe. For another example, user-equipment-to-user-equipment interference occurs when one or user equipment or transmitting uplink signals in a subframe while other user equipment are trying to receive downlink signals in the same subframe.

### SUMMARY OF EMBODIMENTS

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for transmitting an uplink overload indicator in a wireless communication system that operates according to time division duplexing. One embodiment of the method includes transmitting, from a first base station to a second base station, a message indicating that the first base station detected interference in at least one subframe of a time division duplex (TDD) frame allocated for reception of uplink signals at the first base station. A portion of the interference is generated by downlink transmissions from the second base station in the subframe of the TDD frame. Embodiments of base stations may be configured to implement embodiments of this method.

In another embodiment, a method is provided for receiving uplink overload indicators in a wireless communication system that operates according to time division duplexing. One embodiment of the method includes receiving, from a first base station at a second base station, a message indicating that the first base station detected interference in at least one subframe of a time division duplex (TDD) frame allocated for reception of uplink signals at the first base station. A portion of the interference is generated by downlink transmissions from the second base station in said at least one subframe of the TDD frame. This embodiment of the method also includes modifying transmissions from the second base station to reduce interference in the subframe in response to receiving the message. Embodiments of base stations may be configured to implement embodiments of this method.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a wireless communication system;

FIG. 2A conceptually illustrates a second exemplary embodiment of a wireless communication system;

FIG. 2B conceptually illustrates the subframe allocations corresponding to the allocations associated with the cells illustrated in FIG. 2A; and

FIG. 3 conceptually illustrates one exemplary embodiment of a method for managing interference between base stations that use different subframe allocations in time division duplexed communication.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and custom-ary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present application describes embodiments of techniques that can be used to support dynamic reconfiguration of the allocation of subframes to uplink and downlink transmission in a wireless communication system that operates according to time division duplexing (TDD). For example, wireless communication standards such as LTE-Advanced allow different cells, base stations (BSs), or eNBs to select different allocations of the subframes to uplink and downlink transmission. LTE-A also supports dynamic reconfiguration of the uplink/downlink subframes in a TDD system. For example, the subframe allocation of an eNB can be dynamically changed during operation, e.g., the subframe allocation can be reconfigured to select a new allocation from among different subframe configurations supported by LTE-A. However, significant BS-to-BS interference can occur when adjacent base stations use different subframe configurations. For example, a first base station may be operating in one configuration that allocates a subframe for downlink transmissions while an adjacent (second) base station is concurrently operating in a different configuration that allocates the same subframe for receiving uplink transmissions. The second base station may therefore experience significant interference during the subframe if the first base station is providing downlink signaling concurrently with user equipment providing uplink signals to the second base station.

Embodiments of the techniques described herein provide mechanisms that allow base stations that detect interference to signal the interfering base station. The interfering base station may then modify its downlink transmission behavior to mitigate or avoid the interference. For example, a first base station can transmit a message or information element to inform a second (interfering) base station that a mismatch between the TDD subframe allocations of the first and second base stations is leading to a relatively high level of interference in at least one uplink subframe used by the first base station. The detected interference may be produced by downlink transmissions from the second base station in the same subframe. In one embodiment, a flag in the message can be set to indicate that the interference is related to a mismatch between the TDD subframe configurations used by the first and second base stations. In one alternative embodiment, the message may also include a bitmap that indicates the subframes that the first base station identifies as receiving significant interference. In yet another embodiment, a set of bits can be used to indicate the number of uplink subframe that are experiencing interference instead of indicating each individual subframe. These embodiments are not mutually exclusive and may be used in combination with each other.

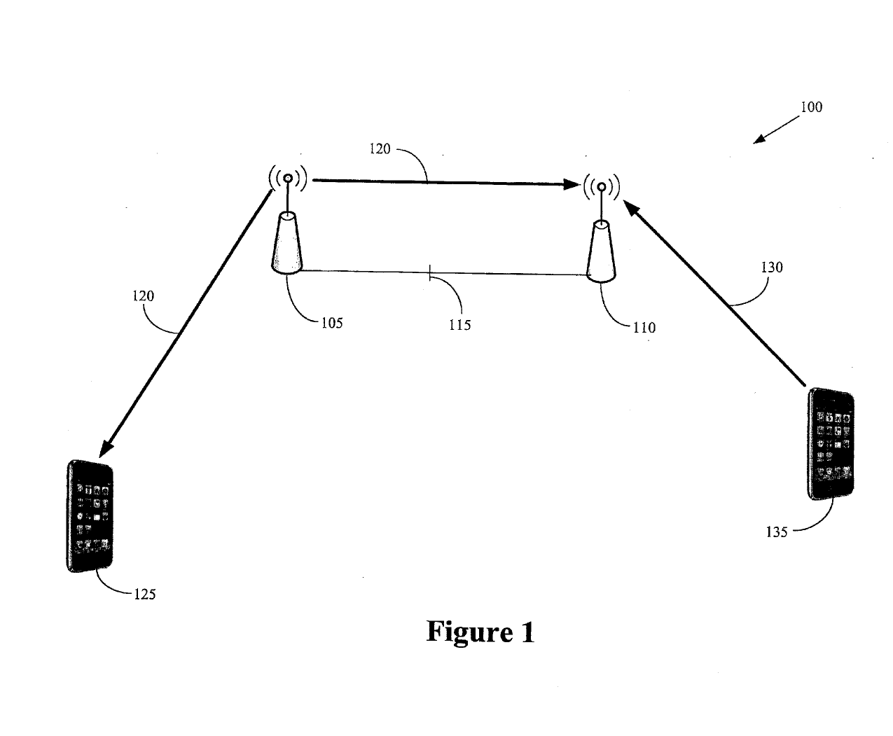

FIG. 1 conceptually illustrates a first exemplary embodiment of a wireless communication system 100. In the illustrated embodiment, the wireless communication system 100 includes base stations 105, 110 that provide wireless connectivity using TDD standards and/or protocols. For example, the base stations 105, 110 may operate according to the LTE-Advanced standards and/or protocols established by 3GPP. However, persons of ordinary skill in the art having benefit of the present disclosure should appreciate that the base stations 105, 110 may alternatively operate according to different standards and/or protocols that support time division duplexing over the air interface. In the illustrated embodiment, the base stations 105, 110 can communicate over an interface 115 by exchanging signaling and/or message is over the interface 115. For example, the interface 115 may be an X2 backhaul interface supported by the wireless communication system 100. The Long Term Evolution (LTE) of the standards and/or protocols defined by the Third Generation Partnership Project (3GPP) specifies an X2 interface for providing signaling between e-node Bs (eNBs). The X2 interface is used to carry signaling related to mobility management, load management, error reporting, and the like. Embodiments of the X2 interface are described in the 3GPP Technical Specification 36.423. However, other embodiments may use other types of interfaces that may include devices such as routers, switches, wired and/or wireless links, and the like to support communication between the base stations 105, 110.

The base stations 105, 110 can be configured to operate using one of a plurality of uplink/downlink allocations of the TDD resource. One exemplary set of uplink/downlink allocations is depicted in Table 1, which shows the uplink/downlink allocations defined by embodiments of the LTE-A standards and/or protocols. Table 1 shows seven different available configurations that have different ratios of downlink-to-uplink resources. The different configurations also provide different switch-point periodicities (5 ms or 10 ms) and allocate different subframes to the downlink (D), uplink (U), and special (S) transmissions. However, persons of ordinary skill in the art having benefit of the present disclosure should appreciate that the allocations indicated in Table 1 are intended to be exemplary and alternative sets of predetermined allocations may also be used. In the illustrated embodiment, the base stations 105, 110 can use any of the available configurations and can dynamically switch between different configurations during operation. Moreover, the base stations 105, 110 may be able to independently reconfigure their uplink/downlink allocations. One of the advantages of TDD systems over FDD systems is that its air-interface frame structure is uplink-downlink asymmetric. Thus, within one TDD frame, the number of uplink TTIs could be different from the number of downlink TTIs and the uplink/downlink ratio can be dynamically configured, e.g., to respond to the variations of the UL-DL traffic, changing environmental or channel conditions, and the like.

TABLE 1

| | | Switch-point | Subframe Number | | | | | | | | | |
|---|---|---|---|---|---|---|---|---|---|---|---|---|
| Configuration | DL:UL Ratio | Periodicity | 0 | 1 | 2 | 3 | 4 | 5 | 6 | 7 | 8 | 9 |
| 0 | 1:3 | 5 ms | D | S | U | U | U | D | S | U | U | U |
| 1 | 1:1 | 5 ms | D | S | U | U | D | D | S | U | U | D |
| 2 | 3:1 | 5 ms | D | S | U | D | D | D | S | U | D | D |
| 3 | 2:1 | 10 ms | D | S | U | U | U | D | D | D | D | D |
| 4 | 7:2 | 10 ms | D | S | U | U | D | D | D | D | D | D |
| 5 | 8:1 | 10 ms | D | S | U | D | D | D | D | D | D | D |
| 6 | 3:5 | 10 ms | D | S | U | U | U | D | S | U | U | D |

Downlink communications from one of the base stations can interfere with the uplink reception of the other base station(s) in the system 100. In the illustrated embodiment, base station 105 is transmitting downlink signals 120 to one or more user equipment 125. The downlink signals 120 are transmitted concurrently with reception of uplink signals 130 from user equipment 135 at the base station 110. For example, the base stations 105, 110 may be using different subframe allocations so that the base station 105 transmits the downlink signal 120 during an allocated downlink subframe that is the same as an uplink subframe allocated to the base station 110 by its corresponding subframe allocation. The downlink signals 120 may be received by the base station 110 during the subframe and may therefore interfere with the uplink signal 130. When the base station 110 determines that interference is present during one or more subframes, the base station 110 may transmit a message to the base station 105 indicating that the base station 110 detected interference caused by downlink signals transmitted by the base station 105 in the subframe that has been allocated for reception of uplink signals at the base station 110. The base station 105 may then modify its downlink transmissions to reduce interference in the subframe, e.g., by reducing transmission power and/or transmitting an almost blank subframe.

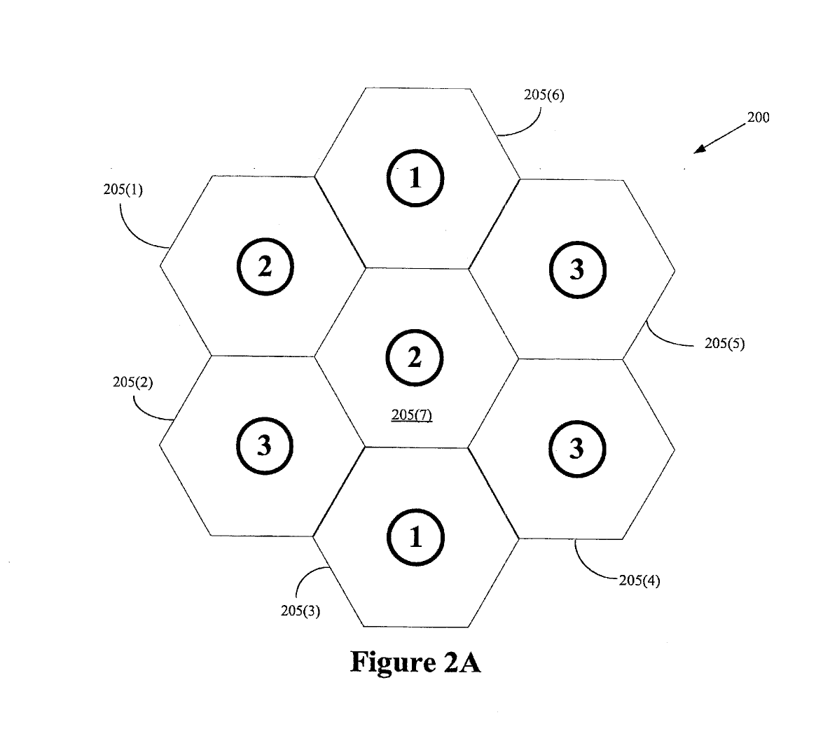

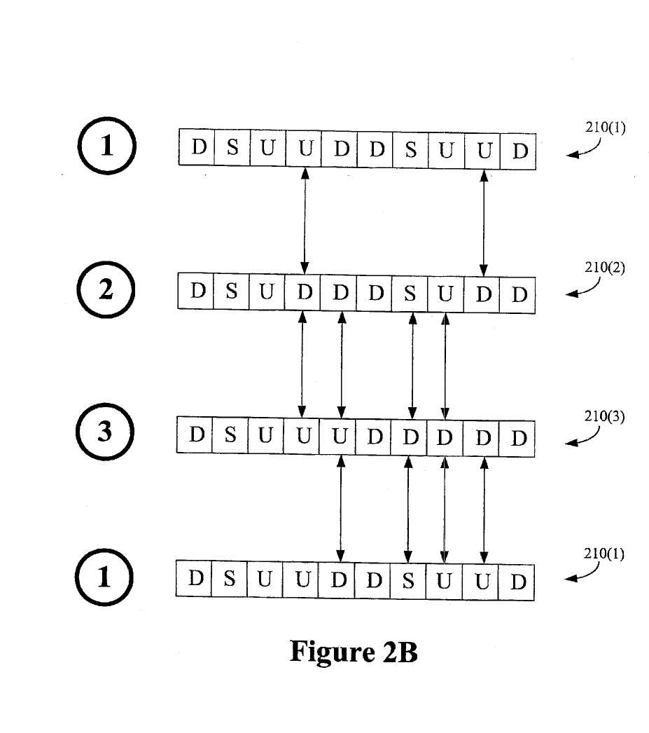

FIG. 2A conceptually illustrates a second exemplary embodiment of a wireless communication system 200. In the illustrated embodiment, the wireless communication system 200 includes a plurality of cells 205. User equipment within the cells 205 may access the wireless communication system 200 over an air interface with one or more base stations or eNBs (not shown in FIG. 2A). The cells 205 may be operated by the same service provider or by one or more different service providers and they may operate according to the same or different standards and/or protocols. In the illustrated embodiment, the cells 205 support time division duplexing. For example, each of the cells 205 may be configured to use one of a plurality of subframe allocations that indicates allocation of the subframes to uplink or downlink transmissions. Different subframe allocations are indicated by the different circled boldfaced numerals within the cells 205. In different embodiments, the allocations may be static or dynamically changing, e.g., to reflect changes in channel conditions, environmental conditions, requested quality of service on the uplink and/or downlink, or other variations in the context.

Mismatches in the subframe allocations that are selected by the different cells 205 and/or are assigned to each cell 205 can lead to inter-cellular interference, which may also be referred to as base-station-to-base-station interference. For example, uplink and downlink transmissions associated with adjacent or nearby cells 205(2, 7) may conflict and interfere when the cell 205(2) allocates a subframe for downlink transmission and the cell 205(7) allocates the same subframe for uplink reception. In that case, the downlink transmissions from the cell 205(2) may interfere with the received uplink transmissions at the cell 205(7), which may make it more difficult to detect and/or decode the received uplink signal. The number of subframes that are mismatched and can potentially interfere depends on the topology of the communication system 200 and the subframe allocations used by the cells 205.

FIG. 2B conceptually illustrates the subframe allocations 210 corresponding to the allocations associated with the cells 205 illustrated in FIG. 2A. In the illustrated embodiment, the subframe allocations show the allocation of 1 ms subframes that have a periodicity of 5 ms (for the subframes 210(1,2)) or 10 ins (for the subframe 210(3)). The subframes can be allocated to downlink (D), uplink (U), or special (S) subframes. The subframe allocation 210(1) is repeated to facilitate a comparison with the allocation of the subframe allocation 210(3). In the illustrated embodiment, the subframe allocations 210(1,2) are mismatched in two subframes, as indicated by the double headed arrows. The fourth and ninth subframes are allocated to uplink (U) transmissions for the subframe allocation 210(1) but they are allocated for downlink (D) transmissions in the subframe allocation 210(2). These mismatched allocations are potential candidates for BS-to-BS interference. The subframe allocations 210(2, 3) are mismatched in four subframes indicated by the double headed arrows and the subframe allocations 210(1, 3) are mismatched in four subframes indicated by the double headed arrows. These mismatched subframes are also potential candidates for BS-to-BS interference.

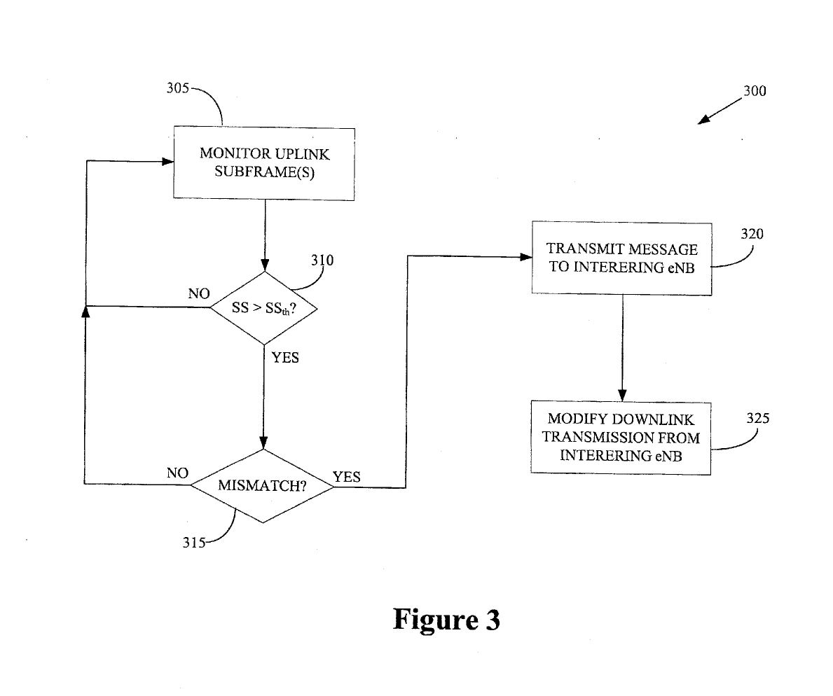

FIG. 3 conceptually illustrates one exemplary embodiment of a method 300 for managing interference between base stations that use different subframe allocations in time division duplexed communication. In the illustrated embodiment, base stations in the system can monitor (at 305) signals received during subframes that are allocated for reception of uplink transmissions from user equipment. For example, the base station can monitor downlink common reference signals or other signals using the network listening mode. The base station can then compare (at 310) the received signal strength to a threshold signal strength. The base station continues to monitor (at 305) the received signal strength as long as the received signal strength remains below the threshold value. However, interference generated by other base stations may cause the base station to detect (at 310) a high signal strength that exceeds the threshold value. For example, downlink transmissions from adjacent base stations that use different subframe allocations can interfere with the received uplink signals if the adjacent base station transmits the downlink signals during one or more subframes that are allocated for reception of uplink transmissions at the monitoring base station.

The base station that detects the interference may determine (at 315) whether there is a mismatch between the subframe allocations at the monitoring base station and at the interfering base station. Different embodiments can use different techniques for determining (at 315) whether a mismatch exists. For example, the network may maintain records of the subframe allocations used by different base stations and this information may be used to detect a mismatch. If no mismatch exists, then the interference may not be BS-to-BS interference and so the base station may continue to monitor (at 305) the uplink subframes. Alternatively, other interference mitigation techniques that are relevant to the particular type of interference that has been detected (at 315) may be used to reduce the interference. If a subframe allocation mismatch exists between the base station and the interfering base station(s), then the base station may transmit (at 320) one or more messages to the interfering base station or eNB.

In one embodiment, the base station may transmit (at 320) a modified version of the uplink overload indicator report. Conventional overload indicator reports instruct the recipient base station to limit the maximum transmission power of user equipment that are scheduled to transmit in uplink physical resource blocks indicated in the overload indicator. For example, in section 9.2.17 of TS 36.423, UL Interference Overload Indicator is an information element that is defined as the following:

| | | | IE type and | |
|---|---|---|---|---|
| IE/Group Name | Presence | Range | reference | Semantics description |
| UL Interference Overload | | 1 to | | |
| Indication List | | <maxnoofPRBs> | | |
| >UL Interference Overload | M | | ENUMERATED | Each PRB is identified by its |
| Indication | | | (high interference, | position in the list: the first |
| | | | medium | element in the list |
| | | | interference, low | corresponds to PRB 0, the |
| | | | interference, . . .) | second to PRB 1, etc. |

In one embodiment, the overload indicator is modified so that the message can be used to instruct the recipient base station to limit its downlink transmission power, e.g., in physical resource blocks that are allocated to uplink transmission in the base station that transmits the overload indicator. For example, the overload indicator information element can be modified to include a field that has a Boolean value that is set to TRUE to indicate a subframe assignment or allocation mismatch between the base station and the interfering base station:

| | | | IE type and | |
|---|---|---|---|---|
| IE/Group Name | Presence | Range | reference | Semantics description |
| UL Interference Overload | | 1 to | | |
| Indication List | | <maxnoofPRBs> | | |
| >UL Interference Overload | M | | ENUMERATED | Each PRB is identified by its |
| Indication | | | (high interference, | position in the list: the first |
| | | | medium | element in the list |
| | | | interference, low | corresponds to PRB 0, the |
| | | | interference, . . . ) | second to PRB 1, etc. |
| >TDD UL-DL Mismatch Flag | O | | BOOLEAN: | True is set when the recipient |
| | | | TRUE or FALSE | eNB TDD Subframe |
| | | | | Assignment is different from |
| | | | | the sender eNB TDD |
| | | | | Subframe Assignment |

In this embodiment, a single bit “Flag” is used to inform the recipient eNB (interferer) that the overload may be related to TDD subframe configuration. See TDD Subframe Assignment in Section 9.2.8. of TS 36.423. Even though the usage of the uplink overload indicator is implementation specific, the actions to be taken by the recipient eNB are different from conventional responses to the overload indicator. For example, the recipient base station may use the information in the message to control or limit downlink transmission in some subframes depending on the subframe assignments used by the different base stations. In some embodiments, the mismatch could be due to changes in the subframe allocations used by either of the base stations. Since the current TDD subframe allocation information element is not designed to be signaled rapidly and contain physical resource block (FRB) information, this adapted overload indicator provides an “indirect” information element to signal the mismatch. The recipient base station may determine which subframes are generating the interference and what actions to take. In one embodiment, signaling of the TDD UL-DL Mismatch Flag may be optional.

In one alternative embodiment, the overload indicator message may include a bitmap to indicate the subframes that are receiving interference above the threshold value. Interfering base stations can use the information in the bitmap to modify downlink transmissions to reduce interference in the subframes identified in the bitmap. The interfering base station can reduce the transition power in the subframes and/or transmit almost blank subframes (ABS). For example, the interfering base stations may transmit almost blank subframes during which the interfering base station bypasses transmission of data traffic, but may continue to transmit system information, broadcast information, timing, reference signals, and the like during the almost blank subframes. An indication of the set of almost blank subframes may then be indicated via existing ABS information signaling. Transmitting a bitmap in the overload indicator could provide not only the locations but also the number of UL-DL interference subframes. In some embodiments, not all downlink transmissions from the interfering base station may lead to interference that is indicated in the bitmap since the interference subframe locations depend on both the subframe assignments of the different base stations and the UE scheduling at the interfering base station. For example, if the interfering base station schedules cell-center UEs in a collision subframe, DL interference in the collision subframe may not trigger the overload indicator message at least in part because lower downlink transmission powers may be used to transmit information to users at the center of a cell.

Two exemplary embodiments of messages that indicate the subframes that include interference are:

| | | | IE type and | |
|---|---|---|---|---|
| IE/Group Name | Presence | Range | reference | Semantics description |
| UL Interference Overload | | Enumeration | | |
| Indication List | | STRING (1 . . . 70) | | |
| >UL Interference Overload | M | | ENUMERATED | Each sub frame is identified |
| Indication | | | (high interference, | by its position in the list: the |
| | | | medium | first element in the list |
| | | | interference, low | corresponds to subframe 0, |
| | | | interference, . . . ) | the second to subframe 1, etc. |

| | | | IE type and | |
|---|---|---|---|---|
| IE/Group Name | Presence | Range | reference | Semantics description |
| UL Interference Overload | | | | |
| Indication List | | | | |
| >UL Interference Overload | M | | BIT STRING | Each position in the bitmap |
| Indication | | | (1 . . . 70) | represents a sub frame, for |
| | | | | which value “1” indicates |
| | | | | sub frame with overload |
| | | | | interference in the UL. |

Yet another alternative embodiment uses the message to transmit information indicating the number of subframes that are experiencing interference at the base station. The overload indicator may include several bits to inform the interfering base station of the number of uplink subframes that are experiencing interference at the “interfered” base station. For example, if three bits are used to indicate the number of subframes experiencing interference, then 000 may be used to indicate no interference, 010 can be used to indicate that two subframes are experiencing interference, and the like. One example of a message that includes bits to indicate the number of subframes that are experiencing interference is:

| | | | IE type and | |
|---|---|---|---|---|
| IE/Group Name | Presence | Range | reference | Semantics description |
| UL Interference Overload | | | | |
| Indication List | | | | |
| >UL Interference Overload | M | | ENUMERATED | 1 bit |
| Indication | | | (high interference, | |
| | | | medium | |
| | | | interference, low | |
| | | | interference, . . . ) | |
| >number of UL Interference | M | | 3 bits | The value of the 3-bit string |
| Overload Sub frame | | | | represents the number of OI |
| | | | | subframes. |

Persons of ordinary skill in the art having benefit of the present disclosure should appreciate that the messages described herein are intended to be exemplary. Furthermore, the exemplary messages are not intended to illustrate mutually exclusive options. In some embodiments, interfaces between the base stations may support combinations and variations of these messages that can be used in different circumstances.

The interfering base station may take steps to modify (at 325) the characteristics of its downlink transmission when the interfering base station receives a message that was transmitted (at 320) by the base station that detected interference in one or more subframes. In one embodiment, the interfering base station may attempt to identify the subframes that are experiencing interference and may then take steps to mitigate the interference. For example, the base station may reduce the transmission power in these subframes. For another example, the interfering base station may transmit almost blank subframes during which the interfering base station bypasses transmission of data traffic, but may continue to transmit system information, broadcast information, timing, reference signals, and the like during the almost blank subframes. An indication of the set of subframes may then be conveyed via existing ABS information signaling. In cases where the interference is due to a mismatch created by a modification in the subframe allocation of one or more of the base stations, either of the base stations may respond to the interference message by stopping the reconfiguration process and reverting back to the previous subframe allocation. For example, if the previous subframe allocation did not include any mismatches that led to interference, the system may revert to the previous subframe allocation. Alternatively, the base stations may negotiate subframe allocations to reduce or illuminate mismatches that lead to interference.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
transmitting, from a first base station to a second base station, a message indicating that the first base station detected interference in at least one subframe of a time division duplex (TDD) frame allocated for reception of uplink signals at the first base station, wherein a portion of the interference is generated by downlink transmissions from the second base station in said at least one subframe of the TDD frame.

2. The method of claim 1, comprising detecting the interference in said at least one subframe at the first base station using a network listening mode to monitor common reference signals transmitted by the second base station.

3. The method of claim 2, comprising detecting the interference in said at least one subframe when signal strengths of said common reference signals are greater than a predetermined threshold value.

4. The method of claim 1, wherein the first base station and the second base station are configured to use first and second allocations of the subframes in the TDD frame for uplink and downlink signaling, and wherein transmitting the message comprises transmitting a message indicating a mismatch between the first and second allocations.

5. The method of claim 4, wherein the first and second allocations are selected from a predetermined set of allocations of the subframes to uplink and downlink signaling.

6. The method of claim 4, comprising detecting interference in said at least one subframe in response to at least one of the first or second base stations modifying the corresponding first or second allocations of subframes.

7. The method of claim 1, wherein the message includes a bitmap comprising entries corresponding to subframes in the TDD frame, and wherein transmitting the message comprises transmitting a bitmap indicating the subframes that are experiencing interference detected by the first base station, wherein the interference is above a threshold.

8. The method of claim 1, wherein the message includes a plurality of bits that can be configured to indicate the number of subframes that are experiencing interference detected by the first base station, wherein the interference is above a threshold.

9. A method, comprising:
receiving, from a first base station at a second base station, a message indicating that the first base station detected interference in at least one subframe of a time division duplex (TDD) frame allocated for reception of uplink signals at the first base station, wherein a portion of the interference is generated by downlink transmissions from the second base station in said at least one subframe of the TDD frame; and
modifying transmissions from the second base station to reduce interference in said at least one subframe in response to receiving the message.

10. The method of claim 9, wherein the first base station and the second base station are configured to use first and second allocations of the subframes in the TDD frame for uplink and downlink signaling, and wherein receiving the message comprises receiving a message indicating a mismatch between the first and second allocations.

11. The method of claim 10, wherein the first and second allocations are selected from a predetermined set of allocations of the subframes to uplink and downlink signaling.

12. The method of claim 10, wherein receiving the message comprises receiving the message in response to at least one of the first or second base stations modifying the corresponding first or second allocations of subframes.

13. The method of claim 9, wherein the message includes a bitmap comprising entries corresponding to subframes in the TDD frame, and wherein receiving the message comprises receiving a bitmap indicating the subframes that are experiencing interference detected by the first base station.

14. The method of claim 9, wherein the message includes a plurality of bits that can be configured to indicate the number of subframes that are experiencing interference detected by the first base station.

15. The method of claim 9, wherein modifying transmissions from the second base station comprises transmitting at least one almost blank subframe in said at least one subframe in the TDD frame.

16. The method of claim 9, wherein modifying transmissions from the second base station comprises reducing at least one transmission power for transmissions in said at least one subframe of the TDD frame.

17. A first base station configured to:
detect interference in at least one subframe of a time division duplex (TDD) frame allocated for reception of uplink signals at the first base station, wherein a portion of the interference is generated by downlink transmissions from a second base station in said at least one subframe of the TDD frame; and
transmit, to the second base station, a message indicating that the first base station detected the interference in said at least one subframe.

18. A first base station configured to:
receive, from a second base station, a message indicating that the second base station detected interference in at least one subframe of a time division duplex (TDD) frame allocated for reception of uplink signals at the second base station, wherein a portion of the interference is generated by downlink transmissions from the first base station in said at least one subframe of the TDD frame; and
modify transmissions from the first base station to reduce interference in said at least one subframe in response to receiving the message.
